(19) United States
(12) Patent Application Publication
(10) Pub. No.: US 2018/0216520 A1
(43) Pub. Date: Aug. 2, 2018

(54) AN INTERNAL COMBUSTION ENGINE

(71) Applicants: Roger John SMITH, Pukekohe (NZ); HIEFF ENGINE COMPANY LTD, Hamilton (NZ)

(72) Inventor: Roger John SMITH, Pukekohe (NZ)

(21) Appl. No.: 15/508,013

(22) PCT Filed: Sep. 2, 2014
(86) PCT No.: PCT/NZ2014/000186

§ 371 Date: Mar. 1, 2017

(51) Int. Cl. F02B 75/04; F02B 77/08

(52) U.S. Cl. CPC F02B 75/045; F02B 77/08

(57) ABSTRACT

An internal combustion engine, primarily for use in motor vehicles, with improved torque and thermal efficiency. The engine comprises pistons configured to move within respective piston cylinders throughout a piston stroke; a rotatable crankshaft; and a piston to crankshaft linkage. A piston connecting rod pivotally connects to the piston at a piston pin; and a crankshaft connecting rod pivotally connects at one end to the piston connecting rod at a connecting rod joint and pivotally connected at another end to the crankshaft. The internal combustion engine also comprises a control arm configured to direct movement of the connecting rod joint to alter an effective length of the piston to crankshaft linkage as the piston to crankshaft linkage is moved via rotation of the crankshaft to form a working crank angle when the piston is a top dead centre position for a predetermined angle of rotation of the crankshaft.

### STATEMENT OF CORRESPONDING APPLICATIONS

The present application is based on the provisional specification filed in relation to New Zealand Patent Application No. 614956.

### TECHNICAL FIELD

The invention relates to improvements in an internal combustion engine. In particular, the present invention relates to an improvement in the connecting rod and crankshaft mechanism of an internal combustion engine which may allow for greater efficiency and increased torque.

### BACKGROUND ART

All references, including any patents or patent applications cited in this specification, are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

A standard internal combustion engine using the Otto thermodynamic cycle is manufactured with a constant compression ratio. This means that when an engine is running under varying load conditions and the piston is reciprocating in the cylinder, the cylinder end space volume remains unchanged.

By way of contrast, in a variable compression ratio (VCR) engine, cylinder end space is altered in volume while the engine is running to produce a variable compression ratio. Such a variable compression ratio can increase fuel efficiency while under varying engine loads and speeds in response to varying driving demands.

A higher load or a full throttle position in an engine requires a lower compression ratio so that the engine can manage the large amounts of air and fuel being compressed and burnt. As the load on the engine is decreased and there are smaller amounts of air and fuel being compressed and burned and the compression ratio needs to become higher and the end space needs to become smaller.

A typical VCR engine will vary the compression ratio from 8-1 to 16-1. Some attempts have been made to make even a larger cylinder end volume change.

A standard petrol engine has a limit on the maximum pressure encountered during the compression stroke, after which the fuel/air mixture detonates rather than burns which could cause engine damage. Normally if higher power outputs are required from an engine, more fuel must be burnt and therefore more air is needed. To achieve this, it is a common practice to use turbochargers or superchargers to force more air into an engine. But this would also result in detonation of the fuel/air mixture unless the compression ratio was decreased.

The ability of a VCR engine is to vary the pressure in the cylinder according to the amount of air and fuel being used by the engine. This provides the advantage of greater thermal efficiency without the dangers of the engine becoming damaged.

An example of a known VCR engine is that disclosed in U.S. Pat. No. 7,021,254. This VCR engine includes a control arm and a connecting rod divided into at least two portions. A control rod is operatively connected to the join of the connecting rod portions. There are a number of features in this design that result in significant inefficiencies of operation.

Firstly, there is no allowance in the design to have a single control arm being able to control a multi cylinder engine. Referring to FIGS. 2 and 3 of U.S. Pat. No. 7,021,254, as pin (26) is solidly fixed to member (25) there is no allowance for some sort of shaft extension or rotatable member that would allow the single control arm to operate other cylinders. Therefore the engine would be expensive to manufacture as a control arm would be needed for every cylinder of a multi-cylinder engine.

Secondly, FIGS. 1 to 6 of U.S. Pat. No. 7,021,254 show that the angle of the connecting rods is always towards the control. This makes it difficult for the connecting rods to maintain a good working angle down through the power stroke while there is high cylinder pressure. This is because the outer radius of the connecting arm 21 will form a relatively small radius, thus providing a relatively inefficient piston motion.

A third disadvantage of with the engine arrangement shown in U.S. Pat. No. 7,021,254 is that when the engine moves to a low compression mode, the crankshaft is not advanced to a better working angle after top dead center (TDC). When the engine moves to the low compression mode, the swept volume of the engine cylinders is reduced and so the low compression can cause a lack of power to the engine.

A further disadvantage with the engine arrangement shown in U.S. Pat. No. 7,021,254 is that indicated that the clearances between the connecting arm (21) and the solidly mounted pivot rod (26) are so fine as to potentially cause the connecting arm (21) to impact upon the pivot rod (26), especially when the engine is in low compression mode resulting in reduced safety of operation.

Further, the engine arrangement shown in U.S. Pat. No. 7,021,254 lacks a safety backstop to stop the control arm from overrunning the precise settings needed for a VCR engine.

A further disadvantage with a standard engine is the relative inefficiency of transferring cylinder pressure to the crankshaft by means of the connecting rod. At TDC there is no working angle for transferring cylinder pressure to the crank to generate torque as the crankshaft offset journal to which the connecting rod is attached, is inline to the center line of the piston, connecting rod, and crankshaft center axis.

At peak cylinder pressure when the crankshaft has turned from its TDC position there is still only a very small working angle on the crankshaft from the centerline of the cylinder, piston and crankshaft axis, and by the time there is a useful working angle on the crankshaft the cylinder has lost most of its pressure to get work done.

### OBJECT OF THE INVENTION

It is an object of the invention to provide an internal combustion engine that addresses at least some of the problems of the prior art, such as those discussed above.

Alternatively, it is an object of the invention to at least provide the public with a useful choice.

### DISCLOSURE OF THE INVENTION

Further aspects and advantages of the present invention will become apparent from the ensuing description which is given by way of example only.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

In a preferred embodiment of the present invention there is provided an internal combustion engine comprising:
at least one piston configured to move within a piston cylinder throughout a piston stroke;
a rotatable crankshaft; and
a piston to crankshaft linkage comprising:
   a piston connecting rod pivotally connected at one end to the piston at a piston pin; and
   a crankshaft connecting rod pivotally connected at one end to the piston connecting rod at a connecting rod joint and pivotally connected at another end to the crankshaft
      wherein the internal combustion engine also comprises a control arm configured to direct movement of the connecting rod joint to alter an effective length of the piston to crankshaft linkage as the piston to crankshaft linkage is moved via rotation of the crankshaft to form a working crank angle when the piston is at its top dead centre (TDC) position for a predetermined angle of rotation of the crankshaft;
      wherein a reduction in the effective length of the piston to crankshaft linkage via the control arm reduces the stroke of the piston within the piston cylinder in a low compression position.

In this way, an improved crankshaft linkage length to piston cylinder stroke is achieved to increase torque output without increasing the stroke as compared to known engine configurations.

Preferably, an increase in the effective length of the piston to crankshaft linkage via the control arm increases the stroke of the piston within the piston cylinder in a high compression position.

Preferably, the ratio between the piston stroke and the length of the piston to crankshaft linkage is less than two.

Preferably, the control arm is configured to move a predetermined distance between the low compression position and the high compression position via a switch.

More preferably, the internal combustion engine also comprises at least one safety backstop configured to limit movement of the control arm in the low compression position and/or high compression position.

In this way, the engine is prevented to overrun by movement of the switch from its correct low compression position and/or high compression position.

Preferably, the working crank angle between the piston connecting rod and the crankshaft connecting rod is between 8 to 10° past the piston TDC position.

Preferably, the piston stroke is reduced in length by between 1 to 15% in the low compression position compared to the length of the piston to crankshaft linkage.

### BRIEF DESCRIPTION OF THE FIGURES

Further aspects of the present invention will become apparent from the following description, which is given by way of example only and with reference to the accompanying figures in which:

FIG. 1 shows a diagrammatic representation of a first preferred embodiment of the present invention in the form of a variable compression ratio internal combustion engine with the crankshaft at top dead centre (TDC; 0° of rotation) and the piston being at TDC with the engine being in the high compression mode;

FIG. 2 shows a diagrammatic representation of the preferred embodiment of FIG. 1 with crankshaft at 10 degrees after TDC (10° of rotation) and the piston being at TDC with the engine being in the low compression mode;

FIG. 3 shows a diagrammatic representation of the preferred embodiment of FIG. 1 showing the control shaft with travel stops and connecting arms configured to allow the engine to use a single control arm to control a single cylinder or multiple cylinders;

FIG. 4 shows a diagrammatic representation of the preferred embodiment of FIG. 1 showing a multi cylinder engine being controlled by a control rod with connecting arms to multiple cylinder and a single control arm;

FIG. 5 shows a diagrammatic representation of the preferred embodiment of FIG. 1 with a single cylinder in the low compression mode where the crankshaft has travelled 10 degrees past its TDC position (10° of rotation) and the piston is at TDC;

FIG. 6 shows a diagrammatic representation of the preferred embodiment of FIG. 5 with the engine in the low compression mode where the crankshaft has travelled 90 degrees past TDC (90° of rotation) without the crank lever having to travel 90 degrees from piston TDC;

FIG. 7 shows the preferred embodiment of FIG. 5 with the engine in the low compression mode where the crankshaft has travelled 180 degrees past TDC (180° of rotation) without the crank lever having to travel 180 degrees from piston TDC;

FIG. 8 shows the preferred embodiment of FIG. 5 with the engine in the low compression mode where the crankshaft has travelled 270 degrees past TDC (270 of rotation) without the crank lever having to travel 270 degrees from piston TDC;

FIG. 9 shows a diagrammatic representation of a preferred embodiment of FIG. 1 with the crankshaft at TDC (0° of rotation) and the piston being at TDC with the engine being in the high compression mode;

FIG. 10 shows the same preferred embodiment of FIG. 9, with the crankshaft rotated 90 degrees past the piston TDC position (90° of rotation);

FIG. 11 shows the same preferred embodiment of FIG. 9, with the crankshaft rotated 180 degrees past the piston TDC position (180° of rotation);

FIG. 12 shows the preferred embodiment of FIG. 9, with the crankshaft rotated 270 degrees past the piston TDC position (270° of rotation);

FIG. 13 shows the preferred embodiment of FIG. 9 in FIG. 13a and of FIG. 2 in FIG. 13b in a side by side comparison of high compression mode and low compression mode respectively;

FIG. 14 shows a second preferred embodiment of the present invention in the form of a variable compression ratio internal combustion engine with a single cylinder in the low compression mode where the crankshaft has travelled 10 degrees past its TDC position (10° of rotation) and the piston is at TDC;

FIG. 15 shows the preferred embodiment of FIG. 14 with the engine in the low compression mode where the crankshaft has travelled 90 degrees past TDC (90° of rotation) without the crank lever having to travel 90 degrees from piston TDC;

FIG. 16 shows the preferred embodiment of FIG. 14 with the engine in the low compression mode where the crankshaft has travelled 180 degrees past TDC (180° of rotation) without the crank lever having to travel 180 degrees from piston TDC and the piston is at the bottom of the cylinder;

FIG. 17 shows the preferred embodiment of FIG. 14 with the engine in the low compression mode where the crankshaft has travelled 270 degrees past TDC (270 of rotation) without the crank lever having to travel 270 degrees from piston TDC;

FIG. 18 shows a graph of shaft angle versus piston displacement of the engine of the second preferred embodiment shown in FIGS. 14 to 17 compared to a conventional non-VCR engine;

FIG. 19 shows a graph of engine pressure versus piston displacement of the engine of the second preferred embodiment shown in FIGS. 14 to 17 compared to a conventional non-VCR engine using the same displacement, bore size and stroke, and the piston height matched to both engines; and

FIG. 20 a graph of engine torque output versus piston displacement of the second preferred embodiment shown in FIGS. 14 to 17 compared to a conventional non-VCR.

### SUMMARY OF THE INVENTION

To get maximum work done by the cylinder pressure on the piston it would be preferable to have the connecting rod attachment to the crankshaft at a working angle to the crankshaft center axis while the piston remained at TDC so that when peak pressure in the cylinder is achieved the working angle on the crankshaft is greatly improved to generate more torque from the cylinder pressure.

To solve this problem the inventors have invented an internal combustion engine with a two piece connecting rod.

The internal combustion engine of the present invention is a variable compression ratio (VCR) engine that has some unique features over known VCR engine designs. Other VCR engine designs alter the low and high compression modes by pulling or pushing on the two main connecting rods which basically shorten or lengthen the distance between the piston wrist pin attachment and the crankshaft offset journal attachment.

Critical to the present invention is the angle of two connecting rods relative to one another, being joined to one another at a pivot and attached to the piston, the crankshaft during the power stroke, or when there is cylinder pressure that pushes on the connecting rods to turn the crankshaft. In the high compression setting, the top connecting rod angle is kept from forming a big angle. The reason for this is the crankshaft TDC matches that of the piston TDC. The TDC position of the crankshaft and the piston occur at the same time. So attention was given to the geometry to ensure a very mild angle on the top connecting rod and a large angle on the bottom connecting rod.

The angling of the connecting rods has a large influence on the piston motion. In high compression mode, the engine of the present invention has piston and crankshaft TDC at the same time, the geometry used to limit the movement of the top connecting rod has made the piston motion of the present invention similar to that of a standard engine with a single connecting rod. During high compression mode, operation the engine of the present invention has the most swept volume as the piston reaches a higher point in the cylinder compared to the low compression setting.

Another critical design feature of the present invention is that the top and bottom connecting rods are always moved away from the connecting arm that is attached to the two main connecting rods from the center line between the piston pin center and the center of the crankshaft. In known VCR engine designs, the connecting rods move from the center line towards the connecting arm or towards the actuating control mechanism. The moving or angling of the connecting rods toward the attached connecting arm will always produce undesirable piston motion because the piston will speed up faster than is desirable for thermal efficiency.

When the engine of the present invention moves into the low compression mode, the piston will stop at a lower position in the cylinder. Because the piston cylinder swept volume has decreased it is common to see a loss of power from the engine because of it being a smaller capacity.

With the engine of the present invention, there is no loss in power for the low compression mode in comparison to the high compression mode using the same cylinder pressure. Independent testing (by Massey University, Auckland, New Zealand) confirms that the geometry that has been designed for the engine of the present invention allows a smaller capacity engine to produce the same power as a conventional higher capacity engine using the same cylinder pressures.

This desirable result comes about when the low compression mode is selected as piston TDC is no longer the crankshaft TDC. The geometric design of the engine of the present invention is such that when the piston reaches the top of the cylinder the crankshaft has advanced past its TDC point to a point of any degree past crank TDC predetermined by the design engineer preferably this could be between 8 to 10 degrees after TDC.

With the crankshaft passing its TDC position by, for example, 10 degrees and the piston reaching TDC there is a working angle on the crankshaft to better utilize the cylinder pressure more efficiently. As the pressure rises in the cylinder and the piston starts to move down the cylinder, the improved working angle on the crankshaft produces more torque than known VCR engine designs that operate via a different geometric principle. More importantly, the connecting rods are kept in a straight line during the power phase of the engine. This straightening of the connecting rods causes the piston to slow down in its movement through the cylinder from TDC.

With the crankshaft being 10 degrees past its TDC at piston TDC, normally the piston speed would be higher than a conventional engine. It is the straightening of the connecting rods that causes the piston to slow down to almost similar speeds to a conventional engine using a single connecting rod. The engine of the present invention has increased torque because of the improved working angle on the crankshaft for piston height. Testing of this geometric principle has confirmed that more torque is produced because of the better working angle on the crankshaft.

The VCR engine of the present invention in low compression mode differentiates itself from other known VCR designs, in that the piston motion during the burn period of the air/fuel mixture is slowed down over the TDC period which improves the thermal efficiency of the engine.

In addition, the VCR engine of the present invention has a larger swept volume when it is in the high compression mode because the piston moves higher in the cylinder, creating less end space as compared to the low compression mode which has a lower swept volume and larger end space. In both modes the VCR engine of the present invention maintains the same bottom dead center (BDC) unlike other VCR designs that alter the position of the piston at TDC and BDC. There is no loss of power using the same cylinder pressure for high compression mode operation when the engine moves to low compression mode. The reason is because the ratio of the crank lever length to stroke is increased during the low compression mode as compared to the ratio of lever length to stroke in the high compression mode when the stroke is increased.

Normally the longer crankshaft lever length would sweep more cylinder volume but the geometry of the VCR engine of the present invention limits the cylinder swept volume but at the same time uses the longer crankshaft lever length to get more work done. As a result the efficiency of the VCR engine of the present invention while it is in low compression mode is similar to the high compression mode. It is these geometric principles that set it apart from known VCR engine designs.

Further, the VCR engine design of the present invention utilizes a single control arm or control unit to change between the high and low compression modes. Known VCR engine designs use a control arm or VCR control unit for each cylinder. This has proved to be very costly in the manufacture of the known VCR engines. These designs also add unnecessary bulk and weight. The VCR engine of the present invention only needs one control arm to control as many cylinders as desired in an engine. A single control arm being used for a multi cylinder engine is a great cost saving in the manufacture of the engine of the present invention and can be conveniently placed at the front or the back of the engine reducing the width of the engine.

### Detailed Description with Best Modes

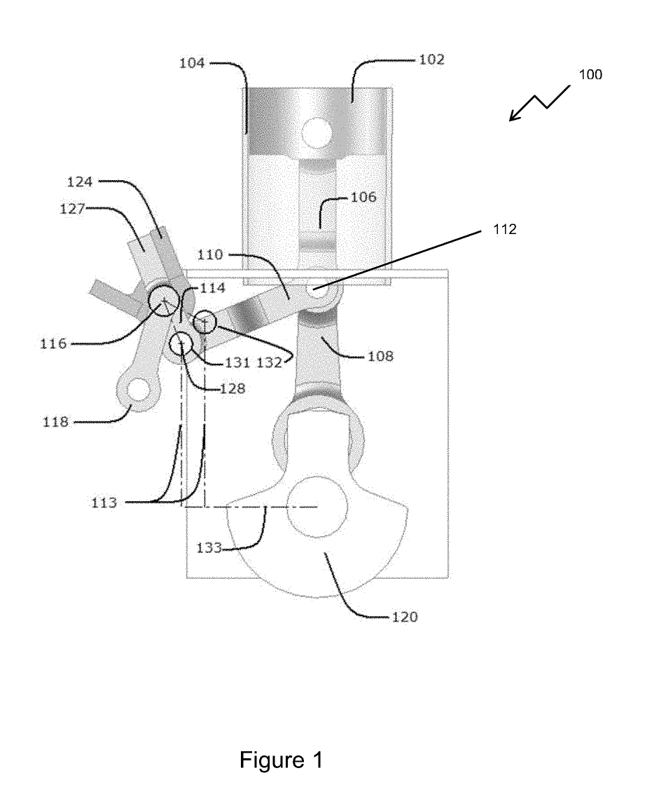

In a preferred form of the invention, an internal combustion engine is generally indicated by arrow 100. FIG. 1 shows a single cylinder VCR engine (100) in the high compression mode setting.

The cylinder (104) has a piston (102) pivotally connected to an upper connecting rod (106), which is joined to a lower connecting rod (108) at a pivot (112), which is in turn pivotally connected to the crankshaft (120). The upper connecting rod (106) and lower connecting rod (108) is pivotally connected to another connecting rod (110) also at pivot (112), and which is pivotally connected at its other end to a control arm (114) at pivot (128). The control arm (114) is solidly fixed to a control rod (116) which has a switch in the form of a control stop arm (127) that is nested against the high compression housing backstop (124) so the variable compression ratio (VCR) movement is unable to overrun the correct positioning for the high compression setting. On the control rod (116) is an control arm (118) configured to rotate the control rod (116) from high compression to low compression. The relative movement of the pivot (128) in low compression and high compression modes are shown by dotted lines (113). Horizontal line (133) travels from the centre of the crankshaft (120) for a set distance. Lines (113) are drawn with each having an end point which is shown by two circles, circle (131) indicates the high compression position of pivot (128) and circle (132) which indicates the low compression position of pivot (128). By this geometric arrangement the control arm (114) does not merely pull or push the connecting rod (110) to alter the angle of the connecting rods (106) and (108). When the control rod (116) is turned and stops at backstop (124), the end of the connecting rod (110) joined to the control arm (114) is stationed exactly at the correct position (128) for high compression indicated by circle (131).

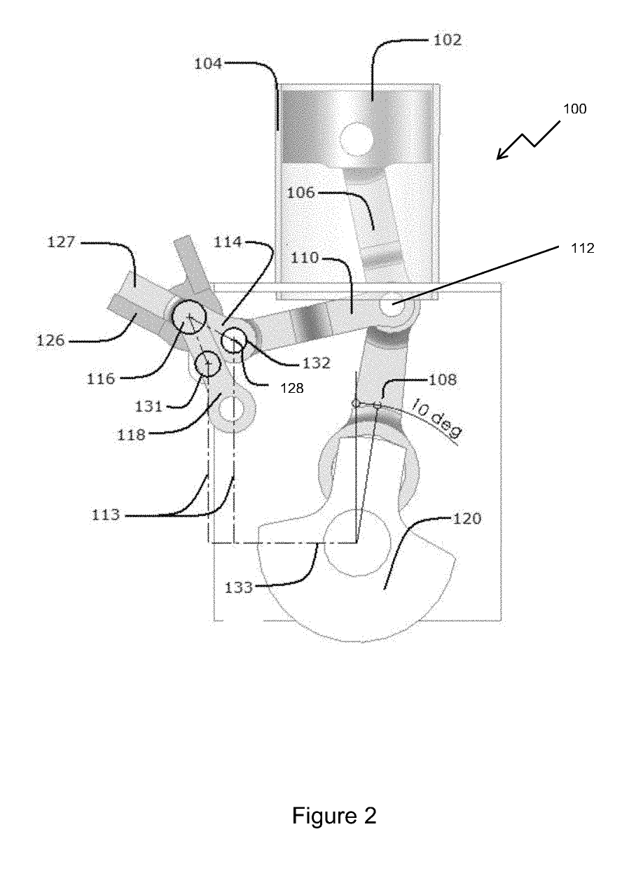

Referring to FIG. 2, the low compression mode setting is achieved when the control rod (116) is turned and stops at the correct backstop in this instance the low compression backstop (126), the pivot (128) is moved to a position indicated by circle (132). In this position the bottom connecting rod (108) has moved to a set angle whereby the crankshaft (120) can rotate past its TDC position without causing the piston (102) to rise to the top of the cylinder (104). When the crankshaft (120) has rotated 10 degrees past its TDC position and becomes aligned with the connecting rod (108) the piston (102) reaches its uppermost position in the cylinder (104). This geometric principle allows for the cylinder pressure to be utilized more efficiently than if the crankshaft (120) was at TDC when the piston (102) reaches its highest position in the cylinder (104).

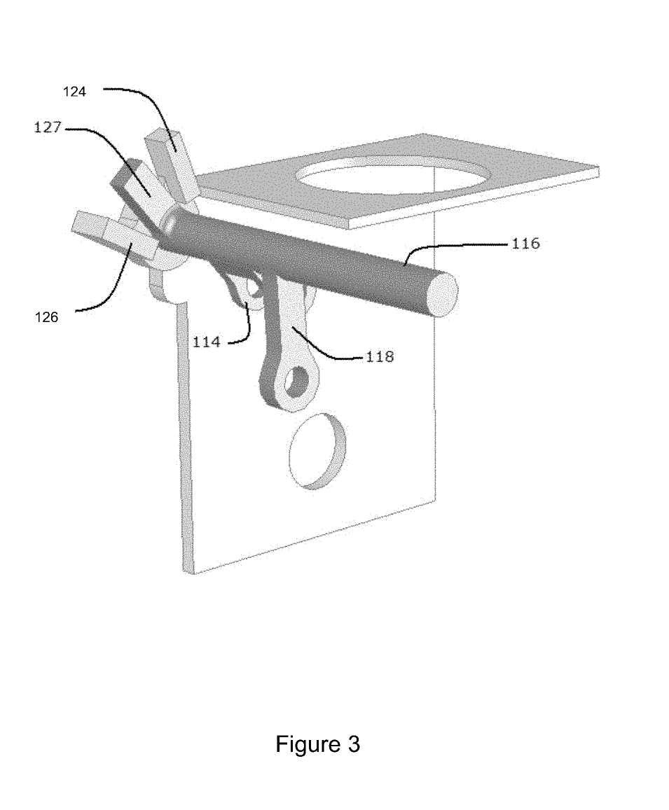

FIG. 3 shows the control rod (116) with control stop arm (127) solidly fixed to the control rod (116). The control stop arm (127) can rest against the high compression backstop (124) and the high compression backstop (126) so the control rod (116) is unable to overrun the correct positioning for the high and low compression positions. A single control arm (114) is shown also solidly fixed to the control rod (116) along with the control arm (118) where an control arm can be fixed to control the high and low compression settings.

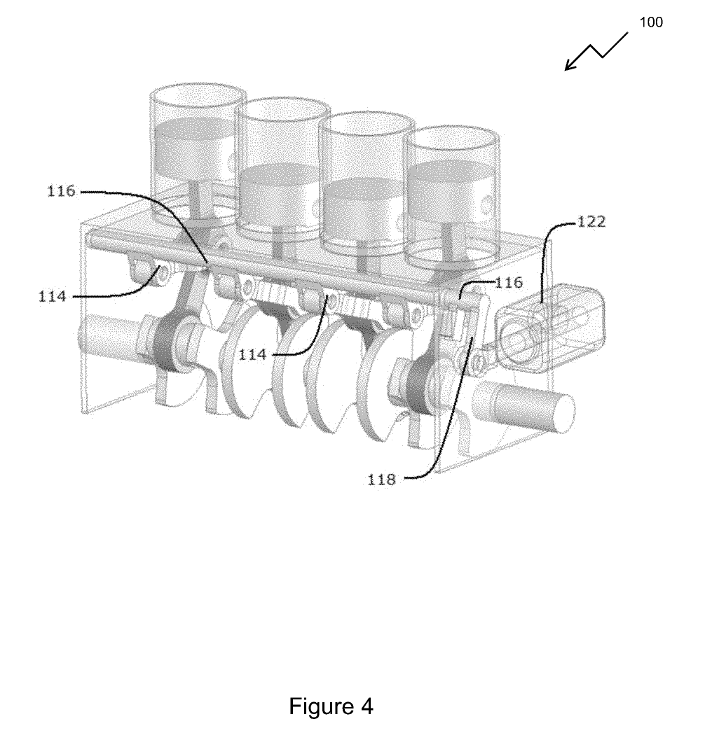

FIG. 4 shows a multi cylinder engine where the control rod (116) can be extended to control a multi cylinder VCR engine with a single control (122). In the multi cylinder engine, the VCR control arm (118) can be placed at the end of the engine. Numerous control arms (114) which are solidly fixed to the control rod (116) can move all the cylinders of an engine between the high and low compression modes at the same time making the engine (100) cost effective to manufacture.

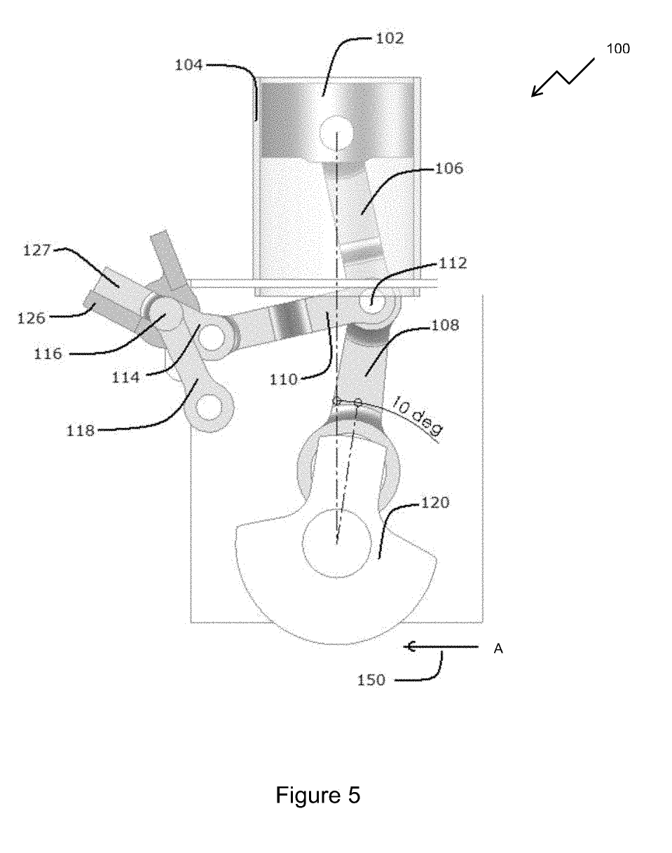

FIG. 5 shows a single cylinder VCR engine (100) in the low compression mode setting. The control stop arm (127) that is nested against the low compression mode backstop (126) to set the low compression mode and moves the bottom connecting rod (108) to a set angle whereby the crankshaft (120) can rotate past its TDC position without causing the piston (102) to rise to the top of the cylinder (104). When the crankshaft (120) has rotated 10 degrees past its TDC position and becomes aligned with the connecting rod (108) the piston (102) reaches its uppermost position in the cylinder (104). This geometric principle allows for the cylinder pressure to be utilized more efficiently than if the crankshaft (120) was at TDC when the piston (102) is at TDC. Note that the crankshaft rotation (150) is in a clockwise direction as denoted by arrow A.

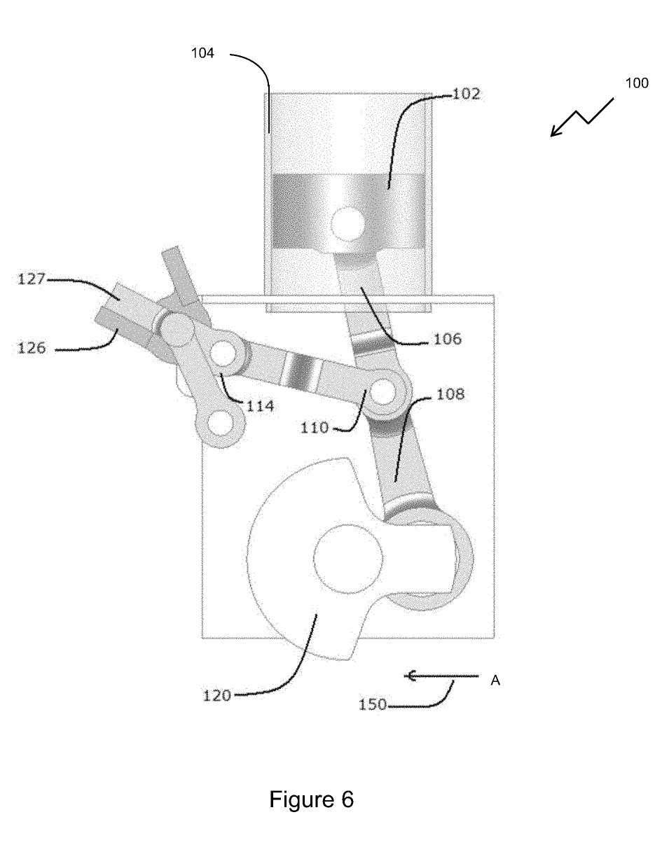

FIG. 6 shows the crankshaft (120) in the 90 degree position from crankshaft TDC but the crankshaft (120) has only having travelled 80 degrees from piston (102) TDC as it began its travel 10 degrees after crankshaft TDC. The upper and lower connecting rods (106 and 108 respectively), have become aligned forming a straight line. The straightening of the upper and lower connecting rods (106) and (108) respectively causes the piston (102) to slow down producing a higher thermal efficiency in its cylinder (104). The control stop arm (127) is resting against the low compression backstop (126) and the connecting rod (110) shows a favoured angle to keep the upper and lower connecting rods 106 and (108) respectively, aligned by being attached to the control arm (114). Note that the crankshaft rotation (150) is in a clockwise direction as denoted by arrow A.

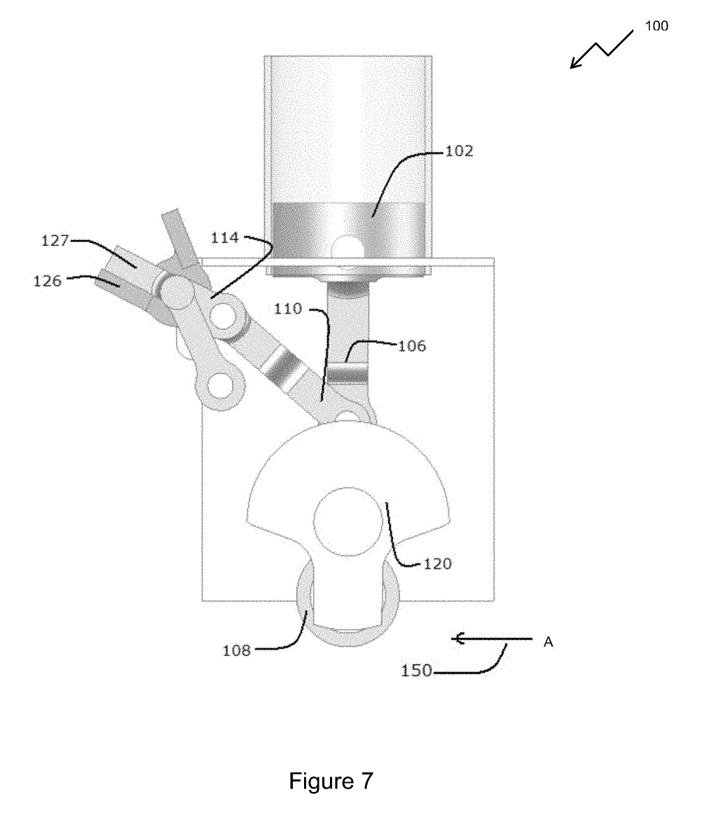

FIG. 7 shows the engine (100) in low compression mode with the piston (102) at the bottom dead centre (BDC) position. The upper and lower connecting rods (106 and 108 respectively), are in an aligned position and the crankshaft (120) has now travelled 170 degrees from the piston (102) TDC. Connecting rod (110) is held in a special position in its attachment to the control arm (114) by the control stop position arm (127) resting against the low compression mode backstop (126).

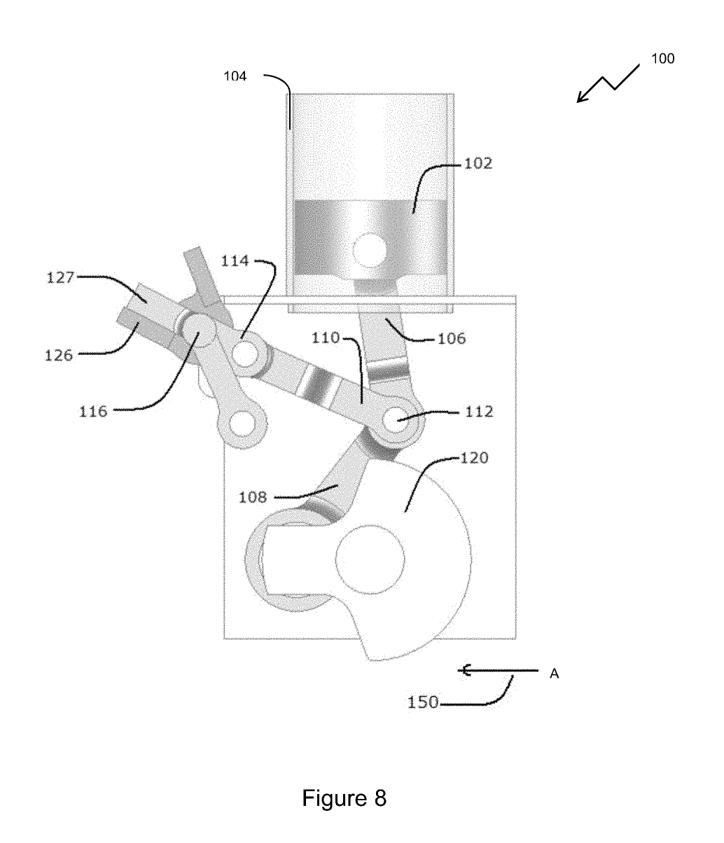

FIG. 8 shows the piston (102) beginning to rise in its cylinder (104) because the crankshaft (120) has now travelled 260 degrees from the piston (102) TDC position. The upper and lower connecting rods (106 and 108 respectively), are now forming different angles because of the aligned position of the connecting rod (110) being attached to the upper and lower connecting rods (106 and 108 respectively), at the flexible join (112) at one end and becoming aligned with the control arm (114) and the control stop arm (127) resting against the low compression mode backstop (126). Because there is only a small amount of work required by the crankshaft (120) and the upper and lower connecting rods (106 and 108 respectively), the larger angle on the upper and lower connecting rods (106 and 108 respectively) can be tolerated by the engine without any damage occurring.

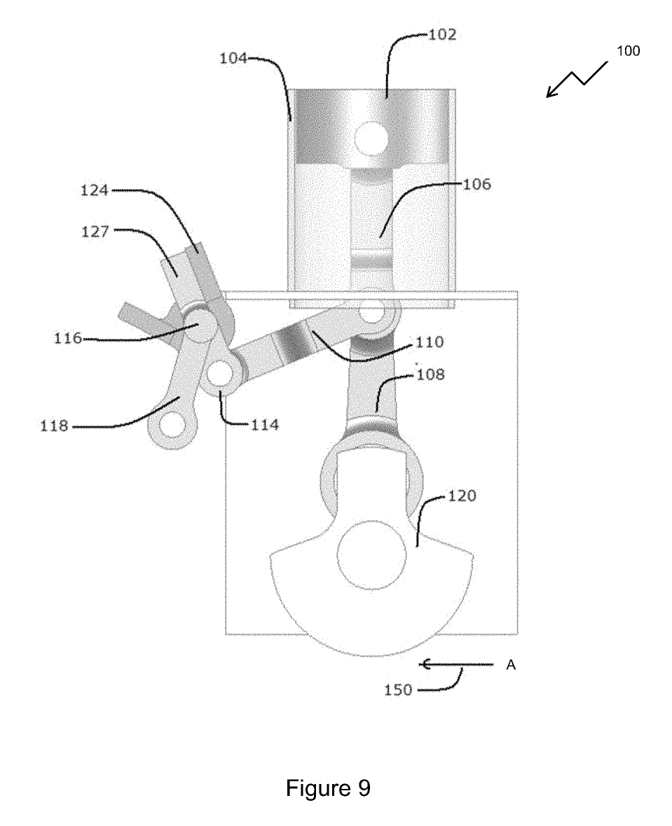

FIG. 9 is a single cylinder VCR engine (100) in the high compression mode setting. The piston (102) is now at the highest position in the cylinder 104. When the control rod (116) is turned the stop position arm (127) is moved to the correct backstop (124) to turn the engine into the high compression mode. In the high compression setting piston (102) TDC is the same as the crankshaft (120) TDC. Note that the crankshaft rotation (150) is in a clockwise direction, as denoted by arrow A.

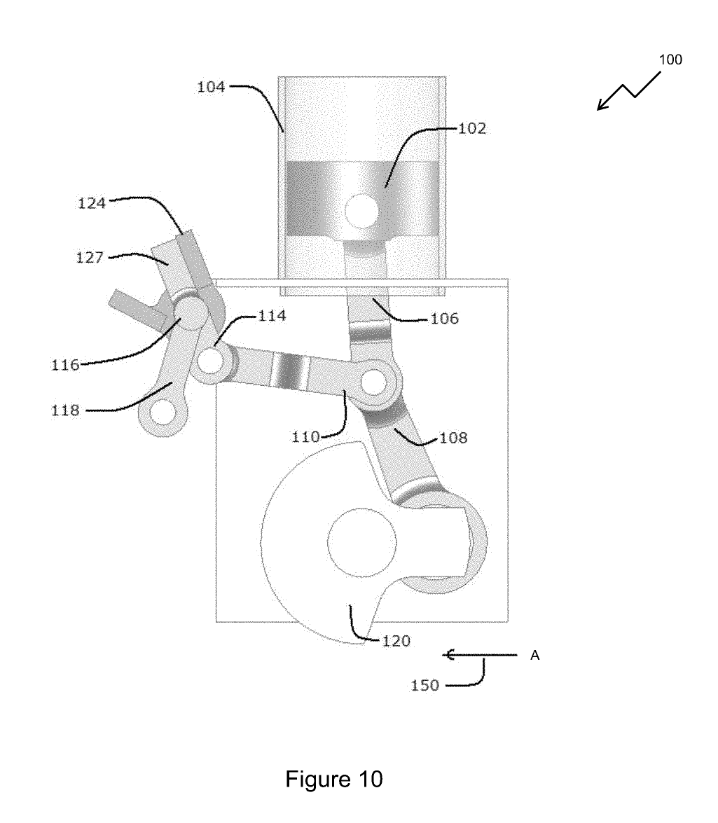

FIG. 10 shows the engine (100) with the crankshaft (120) at 90° after TDC. The piston (102) has travelled down the cylinder (104) and the top connecting rod (106) now has a very mild angle while the bottom connecting rod (108) is more angled. This will produce piston motion that is favourable for the high compression setting. The connecting rod (110) is attached to the control arm (114) and the control rod stop position arm (127) is held against the high compression mode backstop (124) by the control arm (118) pushing on the control rod (116) to keep the engine in the high compression setting. Note that the crankshaft rotation (150) is in a clockwise direction as denoted by arrow A.

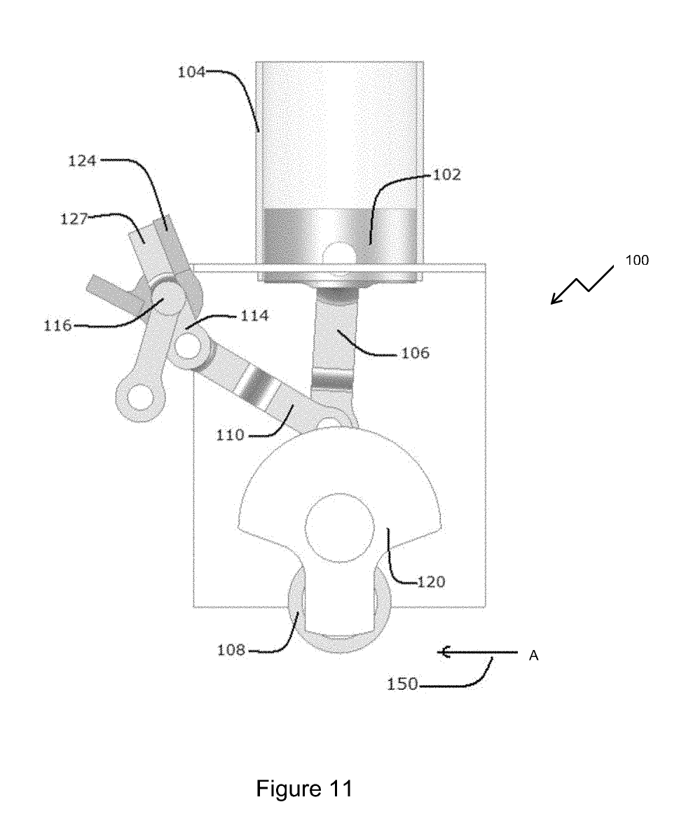

FIG. 11 shows the piston (102) at the bottom of its stroke in the cylinder (104) by the upper connecting rod (106) being joined to the bottom connecting rod (108) and attached to the crankshaft (120) which has turned 180 degrees from the TDC position. The upper and lower connecting rods (106 and 108 respectively) are held in this position by the connecting rod (110) being attached to the control arm (114) and the stop position arm (127) held against the high compression backstop (124). The control rod (116) has been kept in a stationary mode without movement.

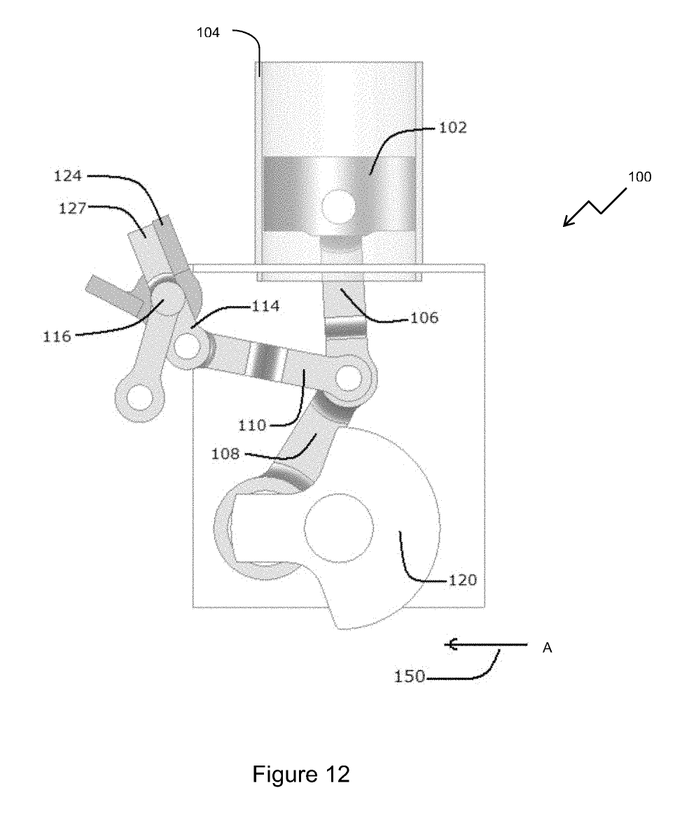

FIG. 12 shows the engine (100) with the piston (102) now travelling up its cylinder (104). The upper and lower connecting rods (106 and 108 respectively) are more angled now, but as the workload is light, the angle of the connecting rods poses no problem for the engine (100). In fact the upper connecting rod 106 has a very small angle during this phase of the engine (100). The position of the control arrangement members (114, 124, 127 and 116) has remained unchanged and the engine is in the high compression mode.

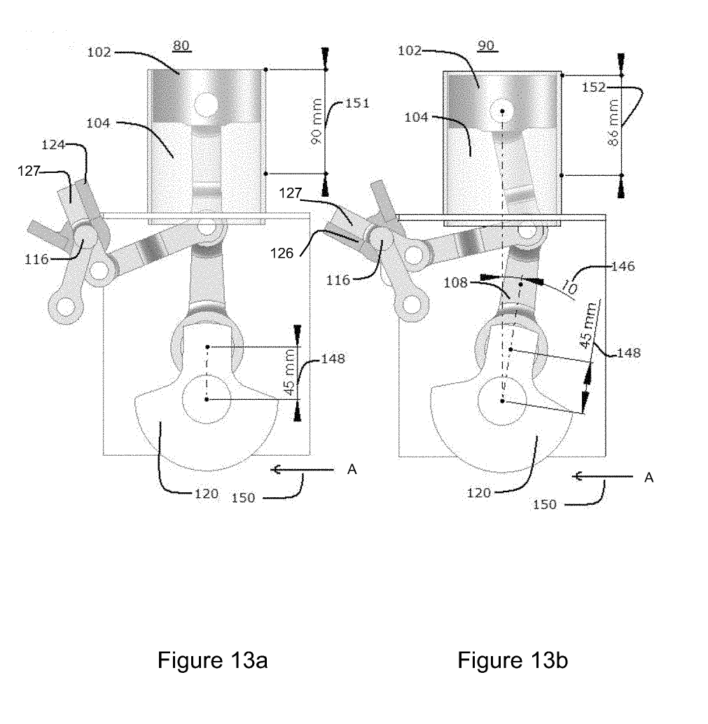

FIG. 13a shows an engine (80) configuration in high compression mode setting. FIG. 13b shows an engine (90) in low compression mode setting. The high compression engine (80) has the piston (102) at the top of the cylinder (104). The control rod (116) has rotated the shaft clockwise and has moved the control stop arm (127) to abut the high compression control backstop (124). The crankshaft (120) rotates clockwise 150 as denoted by arrow A. The distance of the crankshaft throw (148) is 45 mm and as expected the stroke (151) of the engine (80) is 90 mm. This is a normal crank throw to stroke ratio of known engines. The low compression engine (90) on the right shows the piston (102) being further down the cylinder (104) when the piston is at the TDC position. The crankshaft (120) has turned 10 degrees in the clockwise direction shown by arrow A and has become angled by 10 degrees (146). This angle on the crankshaft 120 when it becomes aligned with the lower connecting rod (108) causes the piston (102) to reach TDC. Attention must be paid to the correct rotation (150) of the crankshaft (120). The angle alignment between the crankshaft (120) and the lower connecting rod (108) while the crankshaft (120) turns in the clockwise direction (150) as shown by arrow A by the control rod (116) being turned in an anticlockwise direction to shift the control stop arm (127) to abut the low compression mode backstop (126). In the low compression engine (90) the crankshaft throw (148) to the stroke (152) ratio is altered. Because of the angling of the upper and lower connecting rods (106) and (108) respectively, the crankshaft throw (148) is 45 mm but the stroke (152) of the engine (90) has been reduced from 90 mm (151) to 86 mm (152). This alteration of the crankshaft through (148) to stroke (152) ratio allows the engine (90) to produce more torque while becoming a smaller capacity engine. The crankshaft (120) in engine (90) also has a better working angle (146) which allows it to produce more torque while being a smaller capacity engine in comparison to high compression engine 80.

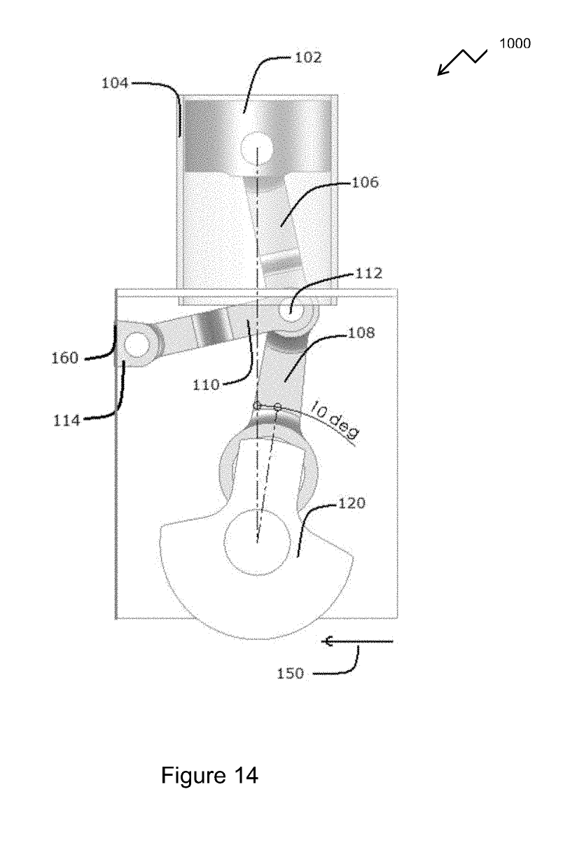

FIG. 14 shows a second embodiment of the present invention in the form of engine (1000) with simplified construction where the high compression housing backstop (124), low compression mode backstop (126), the control stop arm (127), the control rod (116) and the control arm (118) have been removed. The control arm (114) is solidly fixed to the housing (160) and is still attached to the connecting rod (110). The control arm (114) is fixed in the low compression setting. In practice a set compression ratio would be pre-determined by the engine manufacturer for the design of the engine. Attaching the control arm (114) to the housing (160) simplifies the construction of the engine when the engine is to run permanently in a set compression ratio.

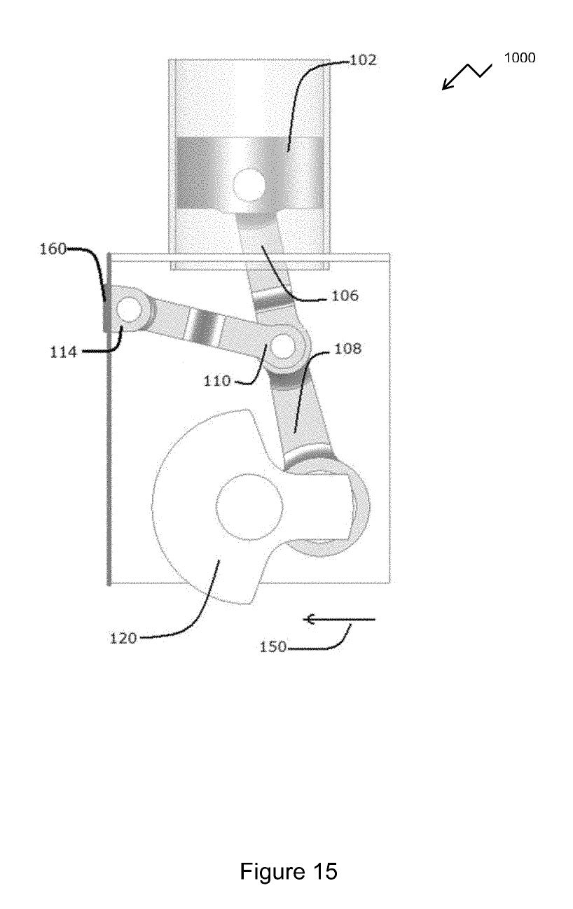

FIG. 15 shows the same general arrangement as engine 1000 in FIG. 6 (except for the modifications described for FIG. 14) and will run exactly the same. The upper (106) and lower (108) connecting rods are aligned which causes the piston (102) to slow down.

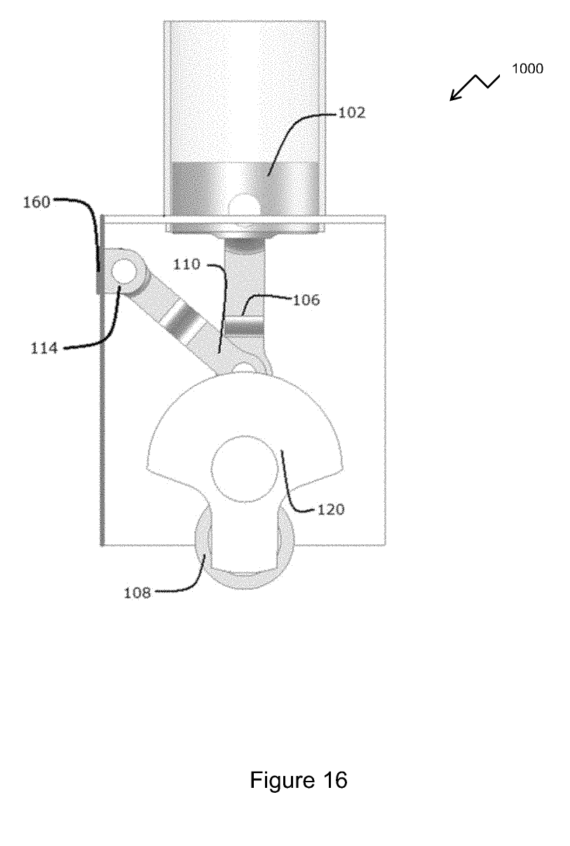

FIG. 16 is equivalent to the arrangement shown in FIG. 7 where the piston (102) is at the bottom of the cylinder (104).

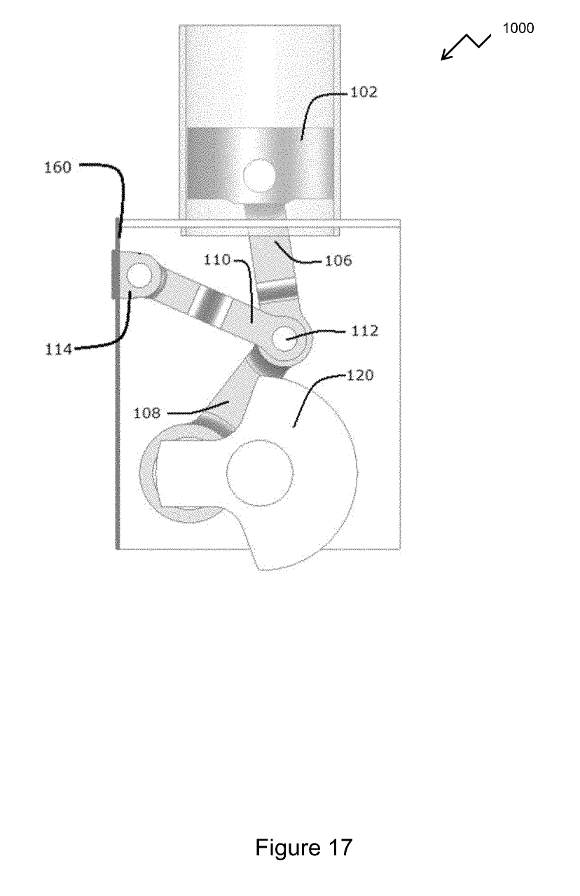

FIG. 17 is equivalent to the arrangement shown in FIG. 8 where the piston (102) is beginning to rise in cylinder (104) because the crankshaft (120) has turned 260° from the piston (102) TDC position.

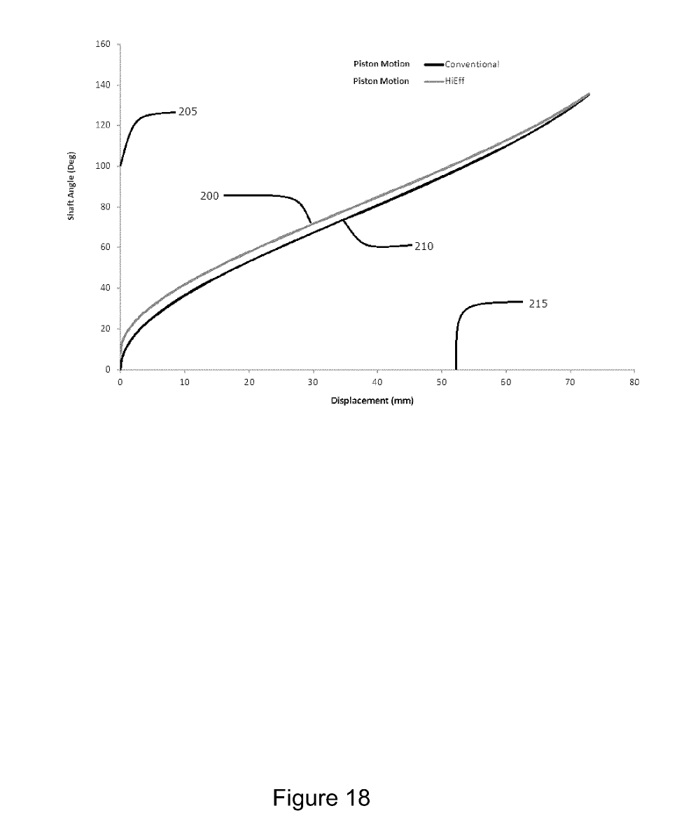

FIG. 18 shows the piston motion of the engine 1000 (“Hieff”) with the control arm (114) solidly fixed to the housing (160) as shown in FIGS. 14 to 17. The top line 200 is the Hieff engine (1000) and the bottom line 210 is a standard engine of a known connecting rod length. In a plot of crankshaft degrees (205) versus displacement (215) the engine (160) shows an increased crankshaft angle over the standard engine over the full range of piston displacement.

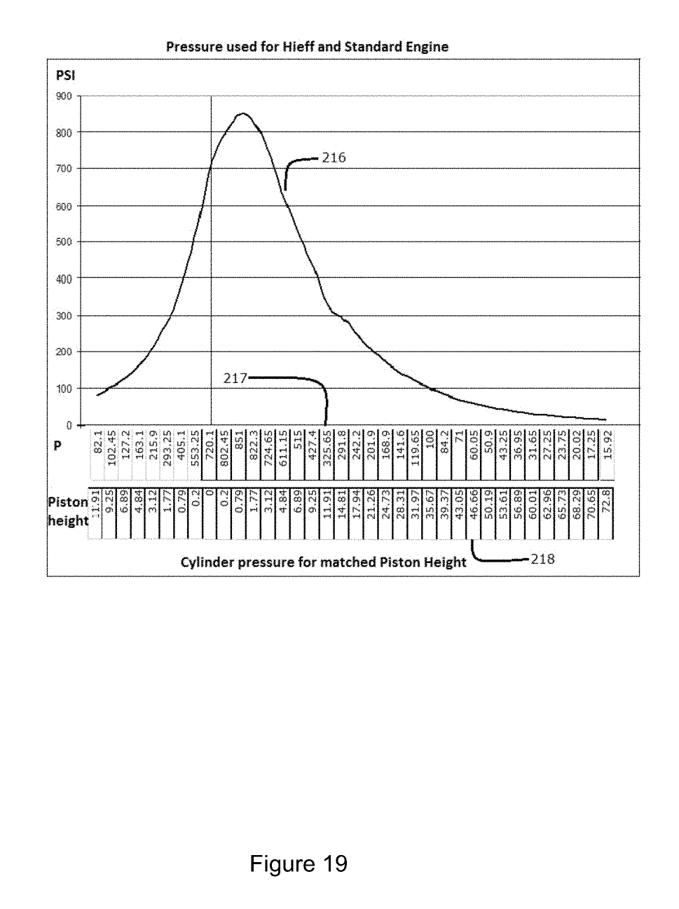

FIG. 19 is a graph of engine pressure (216) versus piston height (218). Pressure (psi) values are shown at 217 and piston height values at 218 and were used to test the torque of the Hieff engine (1000) against a standard engine using the same compression ratio of 10:1, bore size (88 mm) and stroke (82 mm), and the connecting rod length (151.25 mm) matched to both engines so that a direct comparison of torque output could be made. Adams Simulation software was used in this test.

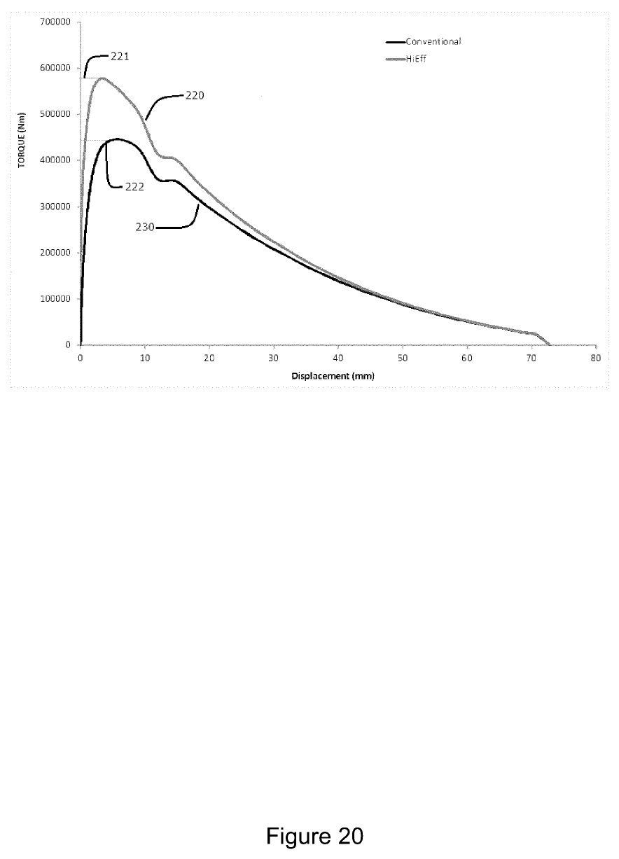

FIG. 20 shows a comparison of the output torque of the standard engine and the Hieff engine (1000) from the simulation shown in FIG. 19 above. The top line 220 is the output torque of the Hieff engine (1000) and the lower line 230 is the output torque of the standard engine. These results show that the Hieff engine (1000) reached a peak torque of 5720 Nm (221) while the standard engine reached a peak torque at 4500 Nm (222). This equates to a 27% improvement in torque.

When the Hieff engine (1000) was used in a high compression setting the efficiency increased to 43% over the standard engine.

### Advantages

The present invention offers notable advantages over the prior art including:
improved efficiency of a spark ignition petrol engine of between 27 to 43% between full throttle and light throttle running conditions;
improved torque output of a compression ignition diesel engine from a given cylinder pressure via a more advanced lever angle on the crank shaft and an improved crank shaft lever length to stroke of engine ratio with improved stroke compared to a conventional internal combustion diesel engine using the same cylinder pressure during the low compression mode;
improved safety through the use of a single control to manage multiple cylinder VCR applications; and
a relative low cost of production of the engine using standard piston and cylinder technology with a modified crankshaft to piston connecting rod linkage and a standard crankshaft.

### Alternatives/Modifications

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof.

1. An internal combustion engine comprising:
at least one piston configured to move within a piston cylinder throughout a piston stroke;
a rotatable crankshaft; and
a piston to crankshaft linkage comprising:
a piston connecting rod pivotally connected at one end to the piston at a piston pin; and
a crankshaft connecting rod pivotally connected at one end to the piston connecting rod at a connecting rod joint and pivotally connected at another end to the crankshaft
wherein the internal combustion engine also comprises a control arm configured to direct movement of the connecting rod joint to alter an effective length of the piston to crankshaft linkage as the piston to crankshaft linkage is moved via rotation of the crankshaft to form a working crank angle when the piston is at its top dead centre (TDC) position for a predetermined angle of rotation of the crankshaft;
wherein a reduction in the effective length of the piston to crankshaft linkage via the control arm reduces the stroke of the piston within the piston cylinder in a low compression position.

2. The internal combustion engine as in claim 1 wherein an increase in the effective length of the piston to crankshaft linkage via the control arm increases the stroke of the piston within the piston cylinder in a high compression position.

3. The internal combustion engine as in claim 1 or claim 2 wherein the ratio between the piston stroke and the length of the piston to crankshaft linkage is less than two.

4. The internal combustion engine as claimed in claim 1 wherein the control arm is configured to move a predetermined distance between the low compression position and the high compression position via a switch.

5. The internal combustion engine as claimed in claim 4 wherein the internal combustion engine also comprises at least one safety backstop configured to limit movement of the control arm in the low compression position and/or high compression position.

6. The internal combustion engine as claimed in claim 1 wherein the working crank angle between the piston connecting rod and the crankshaft connecting rod is between 8 to 10° past the piston TDC position.

7. The internal combustion engine as claimed in claim 1 wherein the piston stroke is reduced in length by between 1 to 15% in the low compression position compared to the length of the piston to crankshaft linkage.
